(19) United States
(12) Patent Application Publication
(10) Pub. No.: US 2006/0210842 A1
(43) Pub. Date: Sep. 21, 2006

(54) Fuel container and fuel cell therewith

(75) Inventors: Fuminobu Tezuka, Yokohama-shi (JP); Yuusuke Sato, Bunkyo-ku (JP); Tatsuya Tashiro, Sunto-Gun (JP); Masato Seki, Gotenba-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignees: KABUSHIKI KAISHA TOSHIBA, Minato-ku (JP); TOKAI CORPORATION, Shibuya-ku (JP)

(21) Appl. No.: 11/366,544

(22) Filed: Mar. 3, 2006

(30) Foreign Application Priority Data
Mar. 11, 2005 (JP) 2005-070061

(51) Int. Cl. H01M 8/00

(52) U.S. Cl. 429/12

(57) ABSTRACT

A cartridge applied to a fuel cell is provided with: a fuel including at least two selected from the group of an organic compound having an ether linkage, an organic compound having an O—H linkage, and water; and a container to house the fuel, the container including one selected from the group of a casing of a resin including naphthalate system polyester and a casing of a metal having an inner coating of a resin including naphthalate system polyester.

### CROSS-REFERENCE TO RELATED APPLICATIONS

This application is based upon and claims the benefit of priority from the prior Japanese Patent Application No. 2005-070061 (filed Mar. 11, 2005); the entire contents of which are incorporated herein by reference.

### BACKGROUND OF THE INVENTION

1. Field of the Invention

The present invention relates to a container for containing a fuel for a fuel cell and the fuel cell using the fuel supplied from the container to generate electricity.

2. Description of the Related Art

In the recent past, development of fuel cells has been emphasized on stationary fuel cells. For the last few years, there is increasing interest in development of a portable fuel cell, which will be applicable to various portable information equipments such as a cellular phone, a notebook PC, etc.

A direct methanol fuel cell (DMFC, hereinafter), in which methanol aqueous solution is directly used as a fuel for power generation, is now proposed to be a preferable type of the portable fuel cell. In the meantime, a reformed hydrogen fuel cell (RHFC, hereinafter) is preferable for generation of relatively high power.

To carry about the portable fuel cell, a compact cartridge for containing and supplying a fuel to the fuel cell is required. Japanese Patent Unexamined Publications S52-45466, H11-166725 and H11-321837 respectively disclose arts of containers or materials preferably applied to containers for containing a fuel.

The cartridge may be required to have the following properties. The cartridge is required to sufficiently protect leakage and permeation of ingredients of the fuel so as to prevent composition change, which leads to change in output power of the fuel cell. The cartridge should be chemically stable against the ingredients of the fuel because it greatly influences safety. Moreover the cartridge preferably has transparency to some degree to show the remaining amount of the fuel to its user. These issues and solutions thereof are not disclosed in the above publications.

### SUMMARY OF THE INVENTION

According to an aspect of the present invention, a container for containing a fuel including at least two selected from the group of an organic compound having an ether linkage, an organic compound having an O—H linkage, and water, is provided with: a casing of a metal; and an inner coating of a resin including naphthalate system polyester.

According to another aspect of the present invention, a cartridge is provided with: a casing of a resin including naphthalate system polyester; and a fuel including at least two selected from the group of an organic compound having an ether linkage, an organic compound having an O—H linkage, and water.

According to still another aspect of the present invention, a container for containing a fuel including at least two selected from the group of an organic compound having an ether linkage, an organic compound having an O—H linkage, and water, is provided with: a casing; and a sealing member of a rubber selected from the group of butyl rubber and perfluoro rubber.

### BRIEF DESCRIPTION OF THE DRAWINGS

FIG. 1 is a perspective view of a cartridge in accordance with an embodiment of the present invention;

FIG. 2 is an exploded perspective view of the cartridge;

FIG. 3 is a cross sectional view of the cartridge;

FIG. 4 is an enlarged cross sectional view of the cartridge;

FIG. 5 is a schematic diagram of a fuel cell system in accordance with an embodiment of the present invention; and

FIG. 6 is a cross sectional view of a cartridge in accordance with another embodiment of the present invention.

### DETAILED DESCRIPTION OF THE INVENTION

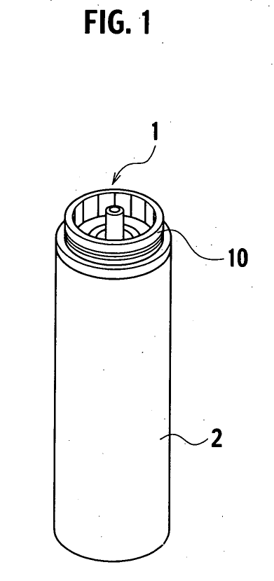

An embodiment of the present invention will be described hereinafter with reference to FIGS. 1 through 6.

As mentioned in the above DESCRIPTION OF THE RELATED ART, a cartridge applied to a fuel cell is required to sufficiently protect leakage and permeation of ingredients of the fuel so as to prevent composition change, be chemically stable against the ingredients of the fuel, and be transparent to some degree. To satisfy the properties, the present inventors have carried out keen studies on materials for the cartridge as described hereinafter.

(A) SEARCH OF MATERIAL

The present inventors have searched materials preferably applied to the cartridge and found that naphthalate system polyester resins such as polyethylene naphthalate (PEN) or polybutylene naphthalate (PBN) are preferably applied to a casing of the cartridge and butyl rubber and perfluoro rubber are preferably applied to a sealing member of the cartridge.

Here, the naphthalate system polyester resins mean any resins having the following general chemical formula; 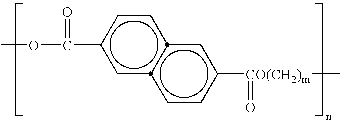
where m and n represent arbitrary integers. Representative examples of the naphthalate system polyester resins are polyethylene naphthalate (PEN) and polybutylene naphthalate (PBN) respectively represented by the following chemical formulae;

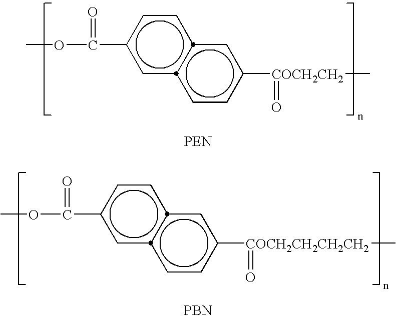

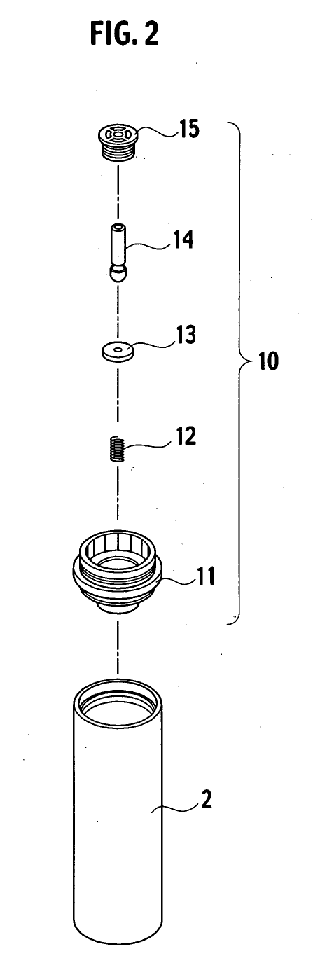

A fuel cartridge (fuel container) 1 for containing a fuel is provided with a casing 2 having an opening at an end thereof and a lid 10 attached to the opening as shown in FIG. 1. The casing 2 may be formed by injection molding and is applied to fuel storage therein as shown in FIGS. 1 and 2.

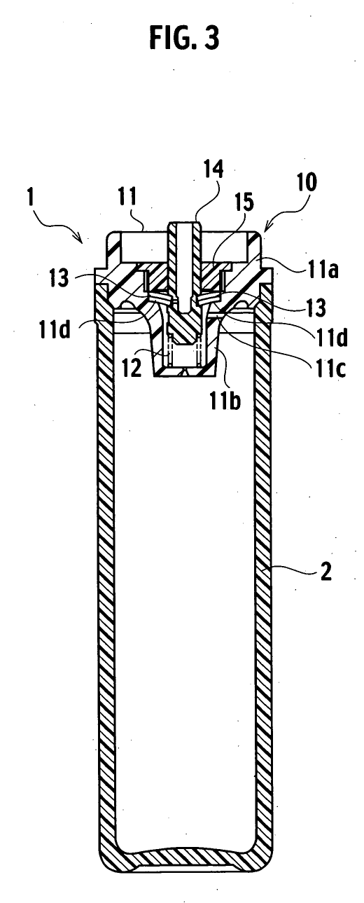

The lid 10 is provided with a housing 11 fixedly attached to the opening of the casing 2, a spring 12 attached to the housing 11, a gasket 13, a stem 14 and a guide screw 15 as shown in FIGS. 2 and 3.

The housing 11 is provided with a frame portion 11a fitting in the opening of the casing 2 and a cylinder portion 11b housing the spring 12. The cylinder portion 11b has an aperture at a bottom thereof and a through hole 11c at a side wall thereof, which link the interior of the casing 2 with an interior of an inner hollow of the cylinder portion 11b to allow the fuel contained in the casing 2 flowing.

The housing 11 is welded with the opening of the casing 2 by ultra-sonic welding. The spring 12 is fit in and on the bottom of the inner hollow of the cylinder portion 11b. The stem 14 to which the gasket 13 made of rubber is attached is disposed on the spring 12.

The housing 11 has a support 11d on which the gasket 13 is disposed. The guide screw 15 is screwed in the housing 11 so as to hold an outer periphery of the gasket 13 between the guide screw 15 and the support 11d.

The guide screw 15 is provided with a through hole substantially at a center thereof, in which the stem 14 is movably supported. When the fuel cartridge 1 is installed in the fuel cell, the stem 14 is pressed into the fuel cartridge 1, namely downward in accordance with illustration by FIG. 3. When pressing down the stem 14, deformation of an inner periphery of the gasket 13 and compression of the spring 12 allow the stem 14 receding into the interior of the inner hollow of the cylinder portion 11b. Then a hole 14b formed on the side wall of the stem 14 links the interior of the inner hollow of the cylinder portion 11b with the exterior of the fuel cartridge 1 via a hollow 14a of the stem 14.

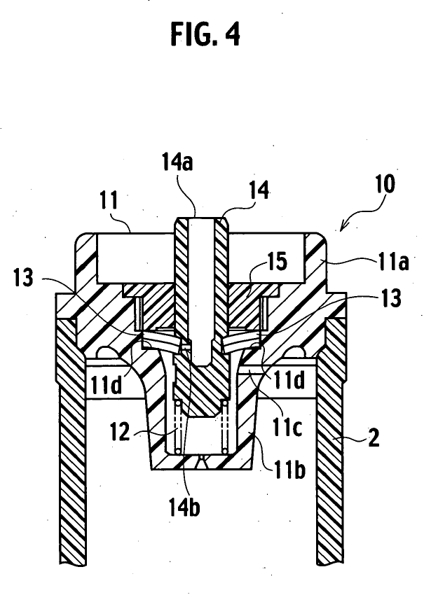

Then the fuel in the cylinder portion 11b poured from the casing 2 flows through the hole 14b and the hollow 14a of the stem 14 and flows out of an outer end of the stem 14. The discharged fuel is supplied to the fuel cell. When the fuel cartridge 1 is detached from the fuel cell, the stem 14 protrudes upward in view of FIG. 4 by repulsive force of the compressed spring 12 and the gasket 13 recovers into the original state so that the hole 14b of the stem 14 comes to be closed.

Meanwhile, the casing 2 may be formed in a triangular or polygonal prism shape.

(1) MATERIAL OF CASING

General properties of the resins had been tested and disclosed already, as indicated in left columns of Table 1. However, resistance of these resins to DME is not fully known. In particular, a chemical system including DME has a considerable tendency to permeate a resin because DME has a vapor pressure of several MPa in the room temperature and hence gives excess pressure to the system. This leads to increased difficulty in estimation of the properties of the resins in the chemical system including DME.

The present inventor has carried out some tests to estimate resistance of some of the resins to a fuel system including DME and water. The tests are carried out under the following two conditions.

(a) 65 degrees C. - 4 hr. test

A test fuel of 9.45 g is produced by adding 3 mol water to 1 mol DME and further adding 10 vol % methanol thereto. The test fuel is poured in a casing subject to the test and left at 65 degrees C. for 4 hours. Weight is measured before and after the test and the external appearance is observed.

(b) 45 degrees C. - 3 days test

A test fuel of 9.45 g is produced by adding 3 mol water to 1 mol DME and further adding 10 vol % methanol thereto. The test fuel is poured in a casing subject to the test and left at 45 degrees C. for 3 months. Weight is measured before and after the test and the external appearance is observed.

Test results are summarized in Table 1. The test results teach that PEN and PBN are preferable in view of weight change and appearance change.

TABLE 1
test results

| | | general properties | | | | | | | | | |
|---|---|---|---|---|---|---|---|---|---|---|---|
| | | | water | | | | after exposure | | after exposure | | |
| | | | absorption | resis- | | | to 65° C.-4 hr | | to 45° C.-3 months | | |
| | | resis- | (%) after | tance | | | weight | | weight | ap- | |
| | sym- | tance | 24 hr/ | to meth- | resitance | | reduction | appearance | reduction | pearance | |
| resins | bols | to DME | 20° C. | anol | to mixture | adhesivity | (%)[IIR] | change | (%)[IIR] | change | overall |
| polyethylene terephthalate | PET | poor | 0.3 | good | poor | middle | | whitened | | whitened | inferior |
| | | | | | | | | with cracks | | with | |
| | | | | | | | | | | cracks | |
| polyethylene naphthalate | PEN | poor | 0.2 | good | good | good | 0.11 | whitened to | 4.78 | whitened | superior |
| | | | | | | | | some extent | | to some | |
| | | | | | | | | | | extent | |
| polybuthylene terephthalata | PBT | middle | 0.03 | good | middle | good | 0.08 | no | 13.48 | no | middle |
| | | | | | | | | abnormality | | abnor- | |
| | | | | | | | | | | mality | |
| polybutylene naphthalate | PBN | good | 0.1 | good | excellent | good | 0.07 | no | 3.88 | no | ex- |
| | | | | | | | | abnormality | | abnor- | cellent |
| | | | | | | | | | | mality | |
| polyamide | PA | good | 1-2 | middle | poor | middle | | | | | inferior |
| polycarbonate | PC | poor | 0.23 | poor | poor | good | | | | | inferior |
| polyacetal | POM | middle | 0.7 | good | middle | good | | | | | middle |
| polypropylene | PP | middle | <0.01 | good | middle | poor | | | | | inferior |
| acrylonitrile.styrene | AS | poor | 0.2-0.3 | poor | poor | good | | | | | inferior |
| acrylonitrile.butadiene.styre | ABS | poor | 0.2-0.35 | poor | poor | good | | | | | inferior |

Appearance abnormality is also checked, where appearance abnormality is defined as degree of whitening of resin.

PBN is inherently white and hence incapable of showing clear appearance change in view of whitening. However, PET, PET+PEN and PEN are inherently transparent and hence capable of showing clear change of degree of whitening. In these test, any of PET, PET+PEN and PEN shows progress in degree of whitening. Further, these resins are subject to an infrared spectroscopic analysis and show great change in infrared spectra.

It is considered that bridges of terephthalate in PET are in part subject to hydrolysis by permeation of DME and water and heating. In contrast, naphthalate is considered insusceptible to hydrolysis.

The casing of any of the resins may be produced by any publicly known production method.

Polyethylene naphthalate (PEN) and polybutylene naphthalate (PBN) may be mixed to be applied. Such a mixture has transparency of PEN and chemical resistance and thermal resistance of PBN and provides these preferable properties for the casing.

(2) MATERIAL OF SEAL MEMBER

Because DME is excellent in permeation as described above, any preferable rubber for a seal member resistive to DME has not been known. In particular, any rubber insusceptible to a chemical system including DME and water has not been known as in the case with the material for the casing.

In view of the above issue, some rubbers having resistance to ketones are selected and tested with respect to resistance to the fuel system including DME and water as described hereinafter.

The tests are carried out under the following two conditions.

(a) immersion test

Test pieces respectively made of the rubbers are immersed in a test fuel of 9.45 g, in which 3 mol water is added to 1 mol DME and 10 vol % methanol is further added thereto, and left at 65 degrees C. for 4 hours. The rubber test pieces are made to be 2.0 mm in thickness and 14 mm in diameter. Weight change and appearance change after 4 hours are tested.

(b) fuel permeation test

A test fuel of 9.45 g is produced by adding 3 mol water to 1 mol DME and further adding 10 vol % methanol thereto. The test pieces are sandwiched in a test container and compressed by 20%. Next the test fuel is poured in the test container and left at 65 degrees C. for 4 hours. Weight reduction is measured and transparency is observed.

The test results are summarized in Table 2.

TABLE 2
test results

| | shortened | weight | size | fuel | | |
|---|---|---|---|---|---|---|
| RUBBER | symbol | reduction | change | permeation | elution | overall |
| butyl rubber | IIR | 15.25% | 6.05% | 1.20% | small | good |
| polyurethane | UR | 20.99% | 11.46% | 4.00% | small | poor |
| rubber (esters) | | | | | | |
| hydrogenated | HNBR | 19.33% | 9.36% | 3.10% | small | poor |
| nitrile butadiene rubber | | | | | | |
| perfluoro rubber | FFKM | 13.08% | 10.19% | 2.20% | small | middle |

As long as judging by the weight change and the size change, although it is hard to say that any rubber is excellent in resistance to the fuel system including DME and water, butyl rubber and perfluoro rubber are superior.

Volume increase and fuel permeation in a system including water and alcohol as well as DME may not be analogically estimated from the above results. Therefore imbibition and permeation tests are carried out. Further resistance tests are carried out with respect to selected materials.

### (B) APPLICABILITY

(1) composition change of fuel

Fuel cartridges as mentioned above (see FIG. 1) made of any of the aforementioned resins and rubbers are practically produced and subject to tests in which decrease and composition change of fuel contained therein are tested.

Conditions of the tests are as same as the tests of the resins and the rubbers. Test results are summarized in Table 3.

TABLE 3
Test results

| | | weight increase |
|---|---|---|
| resin | rubber | ratio |
| PEN | UR | 9.81% |
| PEN | IIR | 4.78% |
| PBN | IIR | 3.88% |
| PBT | IIR | 13.48% |

More specifically, the composition changes in the cartridges to which the present embodiment of the present invention is applied are in the range of 3 to 5 wt %. Therefore, the fuel cartridge in accordance with the present embodiment of the present invention may provide small change in the fuel composition and stable output for a fuel cell.

In particular, the rubber applied to the fuel cartridge preferably excludes plasticizer, because elution of any component of plasticizer, such as dioctyl phtalate (DOP), does not occur. Needless to say, plasticizer is not limited to DOP but may include phtalate esters, adipate esters, phosphoric esters, trimellitate esters, citric esters, epoxy system compounds and polyesters. For general rubber whose hardness is 70, about from 10 to 20 parts of plasticizer is added to 100 parts of rubber, though the appropriate ratio depends on its purpose and application.

As being understood from the above description, the phrase “excluding plasticizer” means that any plasticizer is not added to rubber with the intention, to the extent that would affect the basic and novel characteristics of the product, in the course of production of the rubber. However, the phrase should not be interpreted as excluding small amount of, for example 0.1%, plasticizer mixed as an unintended impurity come from an environment of the production. Either excluding or including may be estimated by either inclusion of 1% or less plasticizer or not, which can be measured by quantitative analysis by any publicly known analyzing method such as a FT-IR or a liquid or gas chromatograph carried out after thermal pressurized cracking or solvent extraction.

In contrast, in a case where another combinations of resins such as PBT and rubbers are applied to the cartridges, the composition changes reaches 10 wt % or such. If the fuel cell is operated with any of these cartridges, DME as a component of the fuel leaks away and is reduced in concentration, which leads to troubles.

Concrete troubles are as follows.

(a) Greater energy is required to compensate heat of vaporization at a time of heating the fuel as the water content per unit volume becomes relatively great.

(b) Smaller amount of hydrogen is gained in a reforming reaction of the fuel because of the reduced concentration of DME.

(c) The smaller amount of hydrogen leads to insufficient temperature increase, thereby a CO shift reaction and a methanation reaction of the fuel insufficiently progress. This results in production of few to few hundreds ppm of CO (carbon monoxide).

(d) This produced CO deteriorates a catalyst of Pt in cells for electricity generation.

(2) safety

Fuel cartridges made of any of the aforementioned resins and rubbers are practically produced and subject to a strength test. As a result, the cartridge in accordance with the present embodiment of the present invention is superior in durability to the cartridge of PET which allows greater DEM permeation and is more susceptible to hydrolysis.

(3) another effects: first—easier visible check

For users of portable fuel cells, it is important to easily check a remaining fuel level, as they need to know how long the battery lasts to enjoy trouble-free user interface of their mobile equipments.

However, to provide the fuel cell system with a detection system for detecting a remaining fuel level may be somewhat troublesome in view of cost, weight and/or size because such a system requires large-scale devices, surveillance systems and controllers. Moreover, the detection system may cause malfunction and result in provision of wrong information.

In contrast, if a fuel cartridge allows users to visibly check the remaining fuel level, these problems may not occur. Such a fuel cartridge provides simpleness, compactness and high reliability.

Regarding this issue, whitening of PEN is slower than that of PET, thereby the fuel cartridge of PEN keeps to allow visible check for 8 hours in a high temperature condition as an imitation of the vehicle interior in summer.

It is possible to mix and apply polyethylene naphthalate and polybutylene naphthalate to the fuel cartridge. It is preferable to mix these resins in a proper ratio to give preferable properties to the fuel cartridge in view of transparency originated from PEN and chemical resistance, thermal resistance and gas barrier property originated from PBN.

Fuel cartridges made of various mixtures of PEN and PBN in various mixing ratios are practically produced with thickness of 2 mm and subject to a thermal resistance test in which the test pieces are left at 65 degrees C. for 4 hours and 8 hours. Test results are summarized in Table 4.

TABLE 4
test results

| | | | | | after exposure to 65° C.-4 hr | | | | | after exposure to 65° C.-8 hr | | | | |
|---|---|---|---|---|---|---|---|---|---|---|---|---|---|---|
| mixing | | initial state | | | diame- | infla- | | defor- | | | infla- | | defor- | |
| ratio | | | diameter | | ter | tion | inflation | mation | | diameter | tion | inflation | mation | |
| PEN | PBN | portion | (mm) | visibility | (mm) | (mm) | rate (%) | at bottom | visibility | (mm) | (mm) | rate (%) | at bottom | visibility |
| 80 | 20 | upper | 20.8 | excellent | 20.9 | 0.10 | 0.5 | small | minimum | 22 | 1.20 | 5.8 | small | minimum |
| | | central | 21.4 | | 21.4 | 0.00 | 0.0 | | | 21.5 | 0.10 | 0.5 | | |
| | | bottom | 20.7 | | 20.6 | −0.10 | −0.5 | | | 20.8 | 0.10 | 0.5 | | |
| 70 | 30 | upper | 21.8 | excellent | 22 | 0.20 | 0.9 | small | minimum | 22 | 0.20 | 0.9 | large | minimum |
| | | central | 21.4 | | 21.55 | 0.15 | 0.7 | | | 21.7 | 0.30 | 1.4 | | |
| | | bottom | 20.7 | | 20.85 | 0.15 | 0.7 | | | 20.9 | 0.20 | 1.0 | | |
| 60 | 40 | upper | 21.8 | excellent | 22 | 0.20 | 0.9 | small | good | 22.2 | 0.40 | 1.8 | large | good |
| | | central | 21.4 | | 21.6 | 0.20 | 0.9 | | | 21.85 | 0.45 | 2.1 | | |
| | | bottom | 20.7 | | 20.9 | 0.20 | 1.0 | | | 20.9 | 0.20 | 1.0 | | |
| 50 | 50 | upper | 21.85 | excellent | 22.1 | 0.25 | 1.1 | large | good | 22.15 | 0.30 | 1.4 | large | good |
| | | central | 21.4 | | 21.9 | 0.50 | 2.3 | | | 21.95 | 0.55 | 2.6 | | |
| | | bottom | 20.8 | | 20.8 | 0.00 | 0.0 | | | 20.8 | 0.00 | 0.0 | | |
| 40 | 60 | upper | 20.8 | good | 22.3 | 1.50 | 7.2 | large | good | 22.4 | 1.60 | 7.7 | large | minimum |
| | | central | 21.35 | | 22.3 | 0.95 | 4.4 | | | 22.6 | 1.25 | 5.9 | | |
| | | bottom | 20.75 | | 20.9 | 0.15 | 0.7 | | | 20.95 | 0.20 | 1.0 | | |
| 30 | 70 | upper | 21.7 | poor | 21.8 | 0.10 | 0.5 | small | poor | 21.85 | 0.15 | 0.7 | small | poor |
| | | central | 21.2 | | 21.6 | 0.40 | 1.9 | | | 21.9 | 0.70 | 3.3 | | |
| | | bottom | 21.75 | | 20.45 | −1.30 | −6.0 | | | 21.75 | 0.00 | 0.0 | | |

In a condition just after production, the cartridges including less than 70 wt % PBN, particularly including 60 wt % or less PBN, assure enough transparency to allow visible check of remaining fuel level from the exterior. However, the cartridges including 70 wt % or more PBN have insufficient transparency so that visible check is impossible.

The cartridges including 40 wt % or less PBN, namely 60 wt % or more PEN, become clouded originated by whitening of PEN after exposure to a high temperature environment for few hours, thereby visible check from the exterior comes to be difficult. More specifically, albeit it depends on the environmental conditions such as temperature, the content of PBN is preferably 0 wt % or more and 70 wt % or less, more preferably 40 wt % or more and 70 wt % or less, and further preferably 40 wt % or more and 60 wt % or less, to assure visible check from the exterior.

Thermal deformation is most prominent in a case of 60 wt % PBN. More specifically, the content of PBN is preferably 0 to 50 wt % or 70 to 100 wt %, more preferably 0 to 40 wt % or 70 to 100 wt %, to prevent thermal deformation.

Meanwhile, the mixture of PEN and PBN may be produced as a pellet in which polymerization partly progresses, or the mixture may be left in a state of monomers, dimers or trimers and, after production of a pellet, polymerized. Mixing of PEN and PBN is preferably carried out in a low molecular state because mixing after polymerization may cause lack of uniformity and decrease in strength thereof.

A preferable range of mixing ratios in view of visible check differs from another preferable range in view of thermal deformation as described above. The mixing ratios may be preferably selected depending on conditions of environments in which the cartridge is used. Moreover, the cartridge may be reinforced so as to endure thermal deformation by introducing any reinforcing structure, for example reinforcement plates or ribs made of steel or stainless steel. Alternatively fillers are in advance mixed in the mixture of resins. Thereby thermal deformation may be prevented with assuring visible check from the exterior if the content of PBN is 40 to 60 wt %.

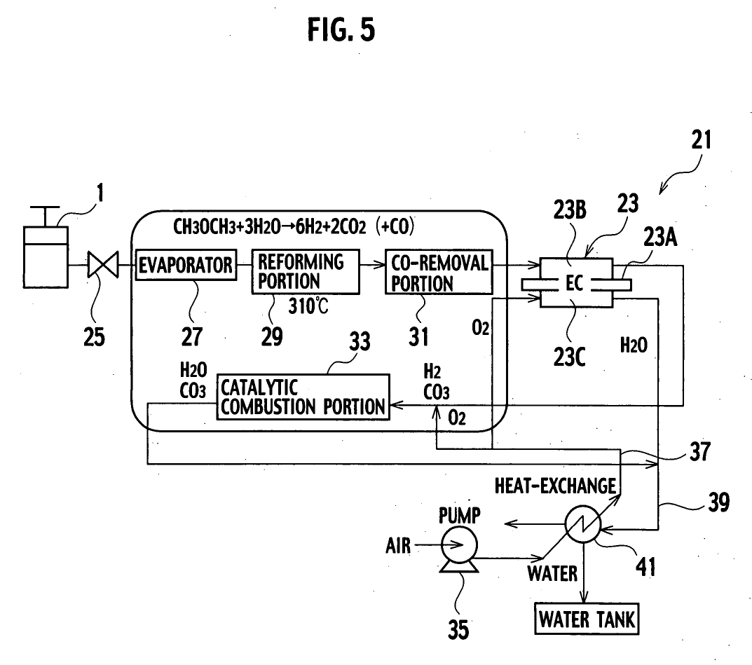

A fuel cell system 21 with the fuel cartridge (fuel container) 1 may be constituted as described hereinafter. The fuel cell system 21 is provided with a fuel cell 23 as illustrated in FIG. 5. The fuel cell 23 is provided with a solid polymer electrolyte membrane 23A, a fuel electrode 23B (including an anodic catalyst) layered on one side of the membrane 23A and an air electrode 23C (including a cathodic catalyst) layered on another side of the membrane 23A.

The fuel cartridge 1 is linked with the fuel electrode 23B via a flow path, in which a fuel supply regulator 25, an evaporator 27, a reforming portion 29 and a CO removal portion 31 intervene in this order. The fuel supply regulator 25 is configured to regulate a flow rate of the fluid supplied to the fuel cell 23 and for example provided with a flow regulation valve. The evaporator 27 receives heat generated at a catalytic combustion portion 33 to evaporate the fuel flowing from the fuel cartridge 1.

The reforming portion 29 is provided with an internal flow path for conducting the evaporated fuel and a reforming catalyst for promoting a reforming reaction of the fuel, which generates a reformed gas including hydrogen. The CO removal portion 31 receives the reformed gas and removes carbon monoxide (CO) contained therein, which is generated as a by-product of the reforming reaction. The catalytic combustion portion 33 is linked with the fuel electrode 23B so as to receive the exhaust gas therefrom and further linked with a pump 35 so as to receive air. The catalytic combustion portion 33 is configured to bring about catalytic combustion of hydrogen left unreacted in the exhaust gas with oxygen in the air.

An air flow path 37 to supply the outside air to the air electrode 23C and the catalytic combustion portion 33 is provided with a heat exchanging portion 41 configured to exchange heat between the air flowing in the air flow path 37 and an exhaust air exhausted from the air electrode 23C and flowing in an air exhaust path 39. Therefore the air is in advance heated before being supplied to the air electrode 23C and the catalytic combustion portion 33.

When the fuel cartridge 1 discharges the fuel contained therein, the fuel including dimethyl ether and water is evaporated at the evaporator 27, and subsequently reformed to be a reformed gas including hydrogen at the reforming portion 29. Carbon monoxide contained in the reformed gas is removed at the CO removal portion 31, and the reformed gas with reduced carbon monoxide is supplied to the fuel electrode 23B of the fuel cell 23. In the meantime, air is introduced by the pump 35 and exchanges heat with the exhaust air from the air electrode 23C of the fuel cell 23. The air thereby pre-heated is supplied to the air electrode 23C and the catalytic combustion portion 33.

Next, unreacted hydrogen contained in the exhaust gas from the fuel electrode 23B is subject to catalytic combustion with oxygen contained in the air supplied from the pump 35 and hence generates heat. The generated heat is used to heating the evaporator 27, the reforming portion 29 and the CO removal portion 31. At the fuel cell 23, hydrogen supplied to the fuel electrode 23B and oxygen supplied to the air electrode 23C are reacted with each other and results in generation of electricity.

Some working examples in accordance with the present embodiment of the present invention will be described hereinafter. In the following description, if not otherwise noticed, rubbers exclude any plasticizer.

### EXAMPLE 1

### PEN-IIR (DME:water=1:4)

A fuel cartridge as shown in FIG. 1 was produced by applying PEN to its casing and IIR to its sealing member. The casing was 20 mm in diameter, 71 mm in height, 2 mm in thickness and about 13.5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 2

### PEN-IIR (DME:water=1:3)

A fuel cartridge as shown in FIG. 1 was produced by applying PEN to its casing and IIR to its sealing member. The casing was 20 mm in diameter, 71 mm in height, 2 mm in thickness and about 13.5 mL in capacity. A mixture of DME of 3.53 g and water of 4.14 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 3

### PEN-FFKM

A fuel cartridge as shown in FIG. 1 was produced by applying PEN to its casing and FFKM to its sealing member. The casing was 20 mm in diameter, 71 mm in height, 2 mm in thickness and about 13.5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 4

### PBN-IIR

A fuel cartridge as shown in FIG. 1 was produced by applying PBN to its casing and IIR to its sealing member. The casing was 20 mm in diameter, 71 mm in height, 2 mm in thickness and about 13.5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

### EXAMPLE 5

### PBN-FFKM

A fuel cartridge as shown in FIG. 1 was produced by applying PBN to its casing and FFKM to its sealing member. The casing was 20 mm in diameter, 71 mm in height, 2 mm in thickness and about 13.5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

### EXAMPLE 6

### methanol (CH₃OH)

A fuel cartridge as shown in FIG. 1 was produced by applying PEN to its casing and IIR to its sealing member. The casing was 20 mm in diameter, 71 mm in height, 2 mm in thickness and about 13.5 mL in capacity. A mixture of DME of 3.53 g, water of 5.53 g and methanol of 0.95 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 7

### ethanol (C₂H₅OH)

A fuel cartridge as shown in FIG. 1 was produced by applying PEN to its casing and IIR to its sealing member. The casing was 20 mm in diameter, 71 mm in height, 2 mm in thickness and about 13.5 mL in capacity. A mixture of DME of 3.53 g, water of 5.53 g and ethanol of 1. 37 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 8

### propanol (C₃H₇OH)

A fuel cartridge as shown in FIG. 1 was produced by applying PEN to its casing and IIR to its sealing member. The casing was 20 mm in diameter, 71 mm in height, 2 mm in thickness and about 13.5 mL in capacity. A mixture of DME of 3.53 g, water of 5.53 g and propanol of 1.78 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 9

### IPA (isopropyl alcohol, (CH₃)₂CHOH)

A fuel cartridge as shown in FIG. 1 was produced by applying PEN to its casing and IIR to its sealing member. The casing was 20 mm in diameter, 71 mm in height, 2 mm in thickness and about 13.5 mL in capacity. A mixture of DME of 3.53 g, water of 5.53 g and isopropyl alcohol of 1.37 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 10

### PEN-IIR

A fuel cartridge as shown in FIG. 1 was produced by applying PEN to its casing and IIR to its sealing member. The casing was 20 mm in diameter, 71 mm in height, 2 mm in thickness and about 13.5 mL in capacity. A mixture of DME of 4.05 g and water of 4.755 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 11

### PEN-IIR

A fuel cartridge as shown in FIG. 1 was produced by applying PEN to its casing and IIR to its sealing member. The casing was 20 mm in diameter, 71 mm in height, 2 mm in thickness and about 13. 5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. In this test, the reformed hydrogen fuel cell system is provided with a concentration sensor and a pressure valve controlled thereby at an inlet of the reforming portion. By the sensor and the pressure valve, the ratio of DME to water was constantly regulated to be 1 to 3 or less. The test showed stable output of 20 W for 30 min with 15 ppm or less carbon monoxide concentration.

In the course of and even after the test, the fuel could be visibly checked from the exterior.

### EXAMPLE 12

### PEN-IIR

A fuel cartridge as shown in FIG. 1 was produced by applying PEN to its casing and IIR to its sealing member. The casing was 20 mm in diameter, 71 mm in height, 2 mm in thickness and about 13. 5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 12 ppm or less carbon monoxide concentration.

In the course of and even after the test, the fuel could be visibly checked from the exterior.

### EXAMPLE 13

### PEN-IIR

A fuel cartridge as shown in FIG. 1 was produced by applying an aluminum can with an internal coating of PEN to its casing and IIR to its sealing member. The casing was 20 mm in diameter, 71 mm in height, 2 mm in thickness and about 13.5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 12 ppm or less carbon monoxide concentration.

### EXAMPLE 14

### PEN-IIR

A fuel reforming system to which a reforming step, a CO shifting step, a methanation step and a combustion step are installed is combined with an electricity generation portion. Further a control system for regulation of them, a thermal system and a safety system are combined therewith to form a fuel cell system as shown in FIG. 5. A test of reforming the fuel using the fuel cell system was carried out.

The test showed stable output of 20 W for 30 min with 12 ppm or less carbon monoxide concentration.

### EXAMPLE 15

### PEN-PBN-IIR

A fuel cartridge as shown in FIG. 1 was produced by applying a mixed resin of 50 wt % PBN and 50 wt % PEN to its casing and IIR to its sealing member. The casing was 20 mm in diameter, 71 mm in height, 2 mm in thickness and about 13.5 mL in capacity. A mixture of DME of 3.53 g, water of 5.53 g and methanol of 0.95 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 16

### PEN-PBN-IIR

A fuel cartridge as shown in FIG. 1 was produced by applying a mixed resin of 30 wt % PBN and 70 wt % PEN to its casing and IIR to its sealing member. The casing was 20 mm in diameter, 71 mm in height, 2 mm in thickness and about 13.5 mL in capacity. A mixture of DME of 3.53 g, water of 5.53 g and methanol of 0.95 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior though visibility was inferior to cases where ratios of PBN/PEN fall in a range of 40/60 to 60/40, which are described in the above and below examples 15, 18 and 19.

### EXAMPLE 17

### PEN-PBN-IIR

A fuel cartridge as shown in FIG. 1 was produced by applying a mixed resin of 70 wt % PBN and 30 wt % PEN to its casing and IIR to its sealing member. The casing was 20 mm in diameter, 71 mm in height, 2 mm in thickness and about 13.5 mL in capacity. A mixture of DME of 3.53 g, water of 5.53 g and methanol of 0.95 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of20 W for 30 min with 20 ppm or less carbon monoxide concentration.

However, both before and after the test, the remaining fuel level could not be visibly checked from the exterior.

### EXAMPLE 18

### PEN-PBN-IIR

A fuel cartridge as shown in FIG. 1 was produced by applying a mixed resin of 40 wt % PBN and 60 wt % PEN to its casing and IIR to its sealing member. The casing was 20 mm in diameter, 71 mm in height, 2 mm in thickness and about 13.5 mL in capacity. A mixture of DME of 3.53 g, water of 5.53 g and methanol of 0.95 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 19

### PEN-PBN-IIR

A fuel cartridge as shown in FIG. 1 was produced by applying a mixed resin of 60 wt % PBN and 40 wt % PEN to its casing and IIR to its sealing member. The casing was 20 mm in diameter, 71 mm in height, 2 mm in thickness and about 13.5 mL in capacity. A mixture of DME of 3.53 g, water of 5.53 g and methanol of 0.95 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

In the course of and even after the test, the fuel could be visibly checked from the exterior.

### EXAMPLE 20

### PEN/stainless steel-IIR

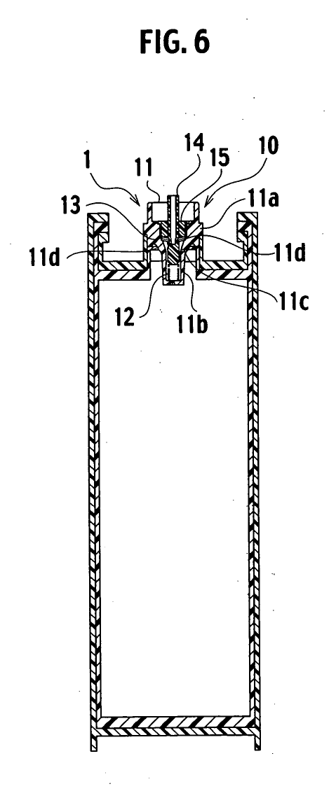

A fuel cartridge as shown in FIG. 6 was produced by applying JIS SUS304 stainless steel (correspondent to AISI 304 stainless steel) with an internal coating of PEN to its casing and IIR to its sealing member. The stainless steel casing is provided with a slit. The casing was 20 mm in diameter, 71 mm in height, 2 mm in thickness and about 13.5 mL in capacity. A mixture of DME of 3.53 g, water of 5.53 g and methanol of 0.95 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed stable output of 20 W for 30 min with 20 ppm or less carbon monoxide concentration.

The remaining fuel level could be visibly checked from the exterior through the slit of the casing.

In the above description, the fuel cartridge slightly differs from the fuel cartridge 1 as aforementioned. However, most of the constitutions are in common. Therefore the detailed description is omitted.

### EXAMPLE 21

### PEN-PBN-IIR

A fuel cartridge as shown in FIG. 1 was produced by applying a mixed resin of 50 wt % PBN and 50 wt % PEN to its casing and IIR to its sealing member. The casing was 20 mm in diameter, 71 mm in height, 2 mm in thickness and about 13.5 mL in capacity. A mixture of DME of 3.53 g, water of 1.38 g and methanol of 0.95 g was filled as a fuel in the casing.

The fuel cartridge containing the fuel had been left at 65 degrees C. for 8 hours. After this, a test of reforming the fuel by supplying the fuel to the reforming portion of the reformed hydrogen fuel cell was carried out. The test showed stable output of 20 W for 30 min.

In the course of and even after the test, the fuel could be visibly checked from the exterior.

### EXAMPLE 22

### PEN-PBN-IIR

A fuel cartridge as shown in FIG. 1 was produced by applying a mixed resin of 50 wt % PBN and 50 wt % PEN to its casing and IIR to its sealing member. The casing was 20 mm in diameter, 71 mm in height, 2 mm in thickness and about 13.5 mL in capacity. A mixture of DME of 3.53 g, water of 1.38 g and methanol of 0.95 g was filled as a fuel in the casing.

The fuel cartridge containing the fuel had been left at 65 degrees C. for 8 hours. After this, a test of electricity generation by supplying the fuel to a direct solid oxide fuel cell (not shown) was carried out. The test showed stable output of 15 W for 30 min.

In the course of and even after the test, the fuel could be visibly checked from the exterior.

### COMPARATIVE EXAMPLE 1

### PBT-IIR

A fuel cartridge as shown in FIG. 1 was produced by applying PBT to its casing and IIR to its sealing member. The casing was 20 mm in diameter, 71 mm in height, 2 mm in thickness and about 13.5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed output power did not reach 20 W and an average output for 30 min was 18 W though carbon monoxide concentration was 20 ppm or less.

In the course of and even after the test, visible check of the fuel from the exterior was harder as compared with a case where PEN is applied to the casing and IIR to its sealing member.

### COMPARATIVE EXAMPLE 2

### PEN-ester system UR

A fuel cartridge as shown in FIG. 1 was produced by applying PEN to its casing and ester system UR to its sealing member. The casing was 20 mm in diameter, 71 mm in height, 2 mm in thickness and about 13.5 mL in capacity. A mixture of DME of 3.53 g and water of 5.53 g was filled as a fuel in the casing.

The fuel cartridge containing the fuel had been left at 65 degrees C. for 8 hours. After this, a test of reforming the fuel using a reformed hydrogen fuel cell with this fuel cartridge as shown in FIG. 5 was carried out. The test showed output power did not reach 20 W and an average output for 30 min was 19 W though carbon monoxide concentration was 20 ppm or less.

As being understood from the above description, the fuel cartridge in accordance with the present embodiment of the present invention is prominently effective in generating pure hydrogen stably and for a long time, which is preferably applied to a fuel cell in particular.

The fuel cartridge assures safety in particular in cases using flammable gases, as gas leakage is small at high temperatures over 60 degrees C.

Moreover, the fuel cartridge enables visible check from the exterior by applying polyethylene naphthalate or a mixture of polyethylene naphthalate and polybutylene naphthalate to the casing so as to assure transparency. Thereby the remaining fuel level is stably enabled.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A container for containing a fuel including at least two selected from the group of an organic compound having an ether linkage, an organic compound having an O—H linkage, and water, the container comprising:
a casing of a metal; and
an inner coating of a resin including naphthalate system polyester.

2. The container of claim 1, wherein the resin includes one selected from the group of polyethylene naphthalate and polybutylene naphthalate.

3. The container of claim 1, wherein the resin includes a mixture of polyethylene naphthalate and polybutylene naphthalate.

4. The container of claim 3, wherein the mixture is formed from monomers, dimers or trimers of polyethylene naphthalate and polybutylene naphthalate.

5. The container of claim 3, wherein a content of polybutylene naphthalate in the mixture is 60 wt % or less.

6. A cartridge comprising:
a casing of a resin including naphthalate system polyester; and
a fuel including at least two selected from the group of an organic compound having an ether linkage, an organic compound having an O—H linkage, and water.

7. The cartridge of claim 6, wherein the resin includes one selected from the group of polyethylene naphthalate and polybutylene naphthalate.

8. The cartridge of claim 6, wherein the resin includes a mixture of polyethylene naphthalate and polybutylene naphthalate.

9. The cartridge of claim 8, wherein the mixture is formed from monomers, dimers or trimers of polyethylene naphthalate and polybutylene naphthalate.

10. The cartridge of claim 8, wherein a content of polybutylene naphthalate in the mixture is 60 wt % or less.

11. A container for containing a fuel including at least two selected from the group of an organic compound having an ether linkage, an organic compound having an O—H linkage, and water, the container comprising:
a casing; and
a sealing member of a rubber selected from the group of butyl rubber and perfluoro rubber.

12. The container of claim 11, wherein the rubber excludes any plasticizer.

13. The container of claim 11, wherein the sealing member is formed by mulling a solid polymer with a liquid polymer.

14. The container of claim 11, wherein the sealing member includes a nozzle to discharge the fuel and is interposed between the nozzle and the casing.

15. A cartridge applied to a fuel cell, comprising:
the container of claim 1; and
a fuel including at least two selected from the group of an organic compound having an ether linkage, an organic compound having an O—H linkage, and water.

16. The cartridge of claim 15, wherein the organic compound having the O—H linkage includes one selected from the group of methanol, ethanol, 1-propanol, and 2-propanol.

17. The cartridge of claim 15, wherein the organic compound having the ether linkage includes dimethyl ether.

18. The cartridge of claim 15, wherein the fuel includes dimethyl ether and water in a ratio of 1 part of dimethyl ether to 1 part or more of water.

19. The cartridge of claim 6, wherein the organic compound having the O—H linkage includes one selected from the group of methanol, ethanol, 1-propanol, and 2-propanol.

20. The cartridge of claim 6, wherein the organic compound having the ether linkage includes dimethyl ether.

21. The cartridge of claim 6, wherein the fuel includes dimethyl ether and water in a ratio of 1 part of dimethyl ether to 1 part or more of water.

22. A cartridge applied to a fuel cell, comprising:
the container of claim 11; and
a fuel including at least two selected from the group of an organic compound having an ether linkage, an organic compound having an O—H linkage, and water.

23. The cartridge of claim 22, wherein the organic compound having the O—H linkage includes one selected from the group of methanol, ethanol, 1-propanol, and 2-propanol.

24. The cartridge of claim 22, wherein the organic compound having the ether linkage includes dimethyl ether.

25. The cartridge of claim 22, wherein the fuel includes dimethyl ether and water in a ratio of 1 part of dimethyl ether to 1 part or more of water.

26. A fuel cell system comprising:
the cartridge of claim 6;
an evaporator to evaporate the fuel supplied from the cartridge;
a reforming portion to reform the evaporated fuel into a reformed gas including hydrogen;
a CO-removal portion to remove carbon monoxide at least in part from the reformed gas to form a product gas;
a ventilator to supply an air including oxygen; and
a fuel cell to generate electricity from the product gas and the air.

27. A fuel cell system comprising:
the cartridge of claim 11;
an evaporator to evaporate the fuel supplied from the cartridge;
a reforming portion to reform the evaporated fuel into a reformed gas including hydrogen;
a CO-removal portion to remove carbon monoxide at least in part from the reformed gas to form a product gas;
a ventilator to supply an air including oxygen; and
a fuel cell to generate electricity from the product gas and the air.
